(19) United States
(12) Patent Application Publication
(10) Pub. No.: US 2020/0163306 A1
(43) Pub. Date: May 28, 2020

(54) ANIMAL LITTER BOX

(71) Applicant: UNICHARM Corporation, Ehime (JP)

(72) Inventors: Chiyo Takai, Kagawa (JP); Shinya Kaneko, Kagawa (JP)

(73) Assignee: UNICHARM Corporation, Ehime (JP)

(21) Appl. No.: 16/774,525

(22) Filed: Jan. 28, 2020

Related U.S. Application Data
(63) Continuation of application No. PCT/JP2017/041655, filed on Nov. 20, 2017.

(30) Foreign Application Priority Data
Jul. 28, 2017 (JP) 2017-146729

(51) Int. Cl. A01K 1/01

(52) U.S. Cl. CPC A01K 1/0107

(57) ABSTRACT

An animal litter box has a front-back direction, a left-right direction, and a height direction. The animal litter box includes: a main body that receives excrement of an animal; and a cover that is removably mounted to an upper portion of the main body. The cover includes walls on front-back-direction sides and on left-right-direction sides. The cover includes an open top at a ceiling, the cover includes a cutout in at least one of the walls. The cutout serves as an entrance/exit when the animal enters or exits the animal litter. The cover includes an extending bottom that extends from a lower end portion of the cutout to an inner side of the at least one of walls.

### CROSS-REFERENCE TO RELATED APPLICATIONS

This application is based on and claims priority under 35 U.S.C. § 119 to Japanese Patent Application No. 2017-146729 filed on Jul. 28, 2017, the contents of which are incorporated herein by reference.

### BACKGROUND

### Technical Field

The present invention generally relates to an animal litter box.

### Related Art

An animal litter box (e.g., for cats) has been conventionally known. For example, PTL 1 discloses the following animal litter box: a cover part is installed above its main body, the four sides thereof are surrounded by walls, and the cover part has a cutout in a part of one of the walls, the cutout serving as an entrance/exit through which an animal enters/exits the toilet.

Patent Literature 1: Japanese Patent Application Publication No. 2008-148603

In such an animal litter box, since the peripheries of the cover part excluding the entrance/exit are surrounded by the walls, it is possible for the animal to safely discharge excrement when the animal has entered the toilet, without being alert its surrounding. However, when the animal discharges the excrement by orienting its excretory opening on the entrance/exit side, the excrement (e.g., feces or urine) leaks from the entrance/exit, and may thus soil the toilet surroundings.

### SUMMARY

One or more embodiments provide an animal litter box that makes less likely for excrement to leak from an entrance/exit.

According to one or more embodiments, an animal litter box has a front-back direction, a left-right direction, and a height direction.

The animal litter box includes: a main body part that receives excrement of an animal; and a cover part that is removably mounted to an upper portion of the main body part.

The cover part includes wall parts on front-back-direction sides and on left-right-direction sides. The cover part has an open top at a ceiling. The cover part has a cutout in at least one location in the wall parts provided on front-back-direction sides and on left-right-direction sides. The cutout serves as an entrance/exit when the animal enters or exits the animal litter box. The cover part includes an extending bottom part that extends inward with respect to the wall part, from a lower end portion of the cutout.

One or more embodiments other than the above will become clear by reading the description of the present specification with reference to the accompanying drawings.

According to one or more embodiments, it is possible to provide an animal litter box that makes less likely for excrement to leak from an entrance/exit.

### BRIEF DESCRIPTION OF THE DRAWINGS

FIG. 1 is a schematic perspective view of an animal litter box according to one or more embodiments.

FIG. 2 is a plan view of the animal litter box when seen from the upper side in the height direction and from the front side in the front-back direction.

FIG. 3 is a cross-sectional view taken along line A-A in FIG. 2.

FIG. 4 is a schematic perspective view of a cover part.

FIG. 5 is a plan view of the cover part when seen from above and from front.

FIG. 6A is a cross-sectional view taken along line B-B in FIG. 5.

FIG. 6B is a cross-sectional view taken along line C-C in FIG. 5.

FIG. 7 is a diagram illustrating a state in which an animal discharges excrement in an animal litter box according to a comparative example.

FIG. 8 is a diagram illustrating a state in which an animal discharges excrement in the animal litter box.

FIG. 9 is an enlarged cross-sectional view of a region D of FIG. 6B.

FIG. 10A is an enlarged view of a region El of FIG. 6A.

FIG. 10B is an enlarged view of a region E2 of FIG. 6B.

FIG. 11 is a diagram illustrating an animal litter box having a cutout in a right wall part.

### DETAILED DESCRIPTION

Embodiments of the present invention will be described herein with reference to the drawings. Those skilled in the art will recognize that many alternative embodiments can be accomplished using the teaching of the present invention and that the present invention is not limited to the embodiments illustrated herein for explanatory purposes.

An animal litter box according to one or more embodiments has a front-back direction, a left-right direction, and a height direction.

The animal litter box includes:

a main body part that receives excrement of an animal; and

a cover part that is removably mounted to an upper portion of the main body part.

The cover part includes wall parts on front-back-direction sides and on left-right-direction sides. The cover part has an open top at a ceiling. The cover part has a cutout in at least one location in the wall parts provided on front-back-direction sides and on left-right-direction sides. The cutout serves as an entrance/exit when the animal enters or exits the animal litter box. The cover part includes an extending bottom part that extends inward with respect to the wall part, from a lower end portion of the cutout.

According to such an animal litter box, the extending bottom part extending inward from the cutout which is the entrance/exit makes it easier to guide an animal to a position situated away from a wall part (that is, toward a far side of the toilet) when the animal enters the toilet. Therefore, inside the animal litter box, the excretory opening of the animal is not easily positioned outside beyond the wall part, making it less likely for excrement to leak from the cutout (the entrance/exit).

According to one or more embodiments, in such an animal litter box, an extending bottom part is inclined obliquely downward from an outer side to an inner side of the wall part.

According to one or more embodiments, in such an animal litter box, even if excrement such as urine is discharged to an upper surface of the extending bottom part, the excrement moves along an inclination of the extending bottom part toward an inner side of the main body part and falls into the main body. This makes it easier to further suppress leakage of the excrement from the cutout (the entrance/exit).

According to one or more embodiments, in such an animal litter box, the extending bottom part includes a bent part at an extending end extending toward the inner side. The bent part is bent downward in the height direction.

According to one or more embodiments, in such an animal litter box, when excrement (e.g., urine) is discharged to the upper surface of the extending bottom part and moves along an inclined surface of the extending bottom part, the excrement easily falls quickly downward (toward the inside of the animal litter box) along the bent part without accumulating in the vicinity of the extending end. Therefore, the excrement does not easily leak from the animal litter box and soiling of a surface of the extending bottom part can be suppressed from occurring.

According to one or more embodiments, in such an animal litter box, the cover part includes extending side parts that extend inward with respect to the wall part, from two left-right-direction ends of the cutout.

According to one or more embodiments, in such an animal litter box, when the animal enters the animal litter box, the animal easily advances to a position situated away from the cutout (the wall part) in correspondence with the amount of inward extension of the extending side parts. Since two sides of the extending bottom part are supported by the extending side parts, the strength of the extending bottom part can be higher than in the case where the two sides of the extending bottom part are not provided with extending side parts. Therefore, when the animal enters the animal litter box, even if the weight of the animal is exerted upon the extending bottom part, the extending bottom part is not easily flexed or damaged, and the animal can more safely use the toilet.

According to one or more embodiments, in such an animal litter box, a width of each of the extending side parts is larger toward a lower side in the height direction.

According to one or more embodiments, in such an animal litter box, by causing the area of each extending side part at a height at which the head passes to be as narrow as possible, it becomes less likely for the animal to bump its head when the animal enters the animal litter box, and this makes it possible to prevent the animal from feeling pressure. On the other hand, by causing the area of each extending side part at a height at which the legs or torso passes to be as wide as possible, it becomes less likely for the extending side parts to be damaged even if, for example, the legs of the animal come into contact with the extending side parts when the animal enters the animal litter box. This can make it less likely for the body of the animal to be injured.

According to one or more embodiments, in such an animal litter box, each wall part includes a reverse part that extends inward with respect to the wall part from a corresponding upper end in the height direction.

According to one or more embodiments, in such an animal litter box, even if the animal that has discharged excrement into the toilet paws particles (e.g., cat sand) after discharging the excrement, the scattered particles collide with the reverse parts at upper end portions of the wall parts, and easily fall toward the inner side of the toilet. Therefore, it is possible to suppress the particles from moving over the upper ends of the wall parts and from flying out.

According to one or more embodiments, in such an animal litter box, a length of the cover part in the front-back direction is longer than a length of the cover part in the left-right direction, and that the cutout is provided in the wall part disposed on a front side or a back side in the front-back direction.

According to one or more embodiments, in such an animal litter box, since the cutout that is the entrance/exit is provided in a portion of a short side of a rectangle, the animal can easily enter or exit the animal litter box in the front-back direction.

According to one or more embodiments, in such an animal litter box, a length of the cover part in the front-back direction is longer than a length of the cover part in the left-right direction, and that the cutout is provided in the wall part disposed on a right side or a left side in the left-right direction.

According to one or more embodiments, in such an animal litter box, the animal can discharge excrement in a region that is wide in a long-side direction, and when discharging the excrement, can also avoid a place where the animal has already discharged the excrement and select a clean place where the animal has not yet discharged excrement. Therefore, the animal can easily discharge excrement without feeling stressed.

According to one or more embodiments, in such an animal litter box, in the front-back direction, a location of a center of the cutout is decentered forward or backward of a location of a center of the animal litter box.

According to one or more embodiments, in such an animal litter box, the animal litter box is separated into the following two places: a place situated in the vicinity of the entrance (the cutout) where excrement can be easily discharged; and a place situated away from the entrance where excrement cannot be easily discharged. This makes it easier for the two regions to be used in this order. Therefore, the animal litter box is easily used efficiently over a wide range.

According to one or more embodiments, in such an animal litter box, in the front-back direction, a maximum value of a width of the cutout is ½ or less of a maximum value of a width of the wall part where the cutout is provided.

According to one or more embodiments, in such an animal litter box, of the wall parts that are elongated in the longitudinal direction, the location to which the animal advances into the toilet is easily limited to a desired location. Therefore, it is possible to easily control a place in the vicinity of the entrance in the longitudinal direction where excrement is easily discharged and a place situated away from the entrance in the longitudinal direction where excrement is not easily discharged, and the entire region of the animal litter box can be efficiently used.

According to one or more embodiments, in such an animal litter box, an extension length from a lower end of the cutout to an extending end of the extending bottom part is between 1 cm to 10 cm (both inclusive).

According to one or more embodiments, in such an animal litter box, setting the extension length to be greater than or equal to 1 cm makes it easier to guide the animal to the far side of the toilet in the front-back direction. Setting the extension length to be less than or equal to 10 cm makes it easier to suppress the animal from feeling stressed or from feeling hesitant to use the animal litter box, which are caused by narrow space where the animal discharges excrement inside the toilet. Therefore, the animal can easily discharge the excrement at a proper location inside the animal litter box without feeling stressed.

According to one or more embodiments, in such an animal litter box, the extending bottom part is inclined obliquely downward from an outer side to an inner side of the wall part, and that, of angles that a straight line connecting a lower end of the cutout and an extending end of the extending bottom part form with a horizontal plane, a smaller angle is between 5 degrees and 45 degrees (both inclusive).

According to one or more embodiments, in such an animal litter box, by causing the inclination angle to be greater than or equal to 5 degrees, excrement (e.g., urine) discharged to the upper surface of the extending bottom part easily flows and is easily suppressed from accumulating. If the inclination angle is set less than or equal to 45 degrees, the animal's legs do not easily slip when the animal places its legs on the extending bottom part to enter the animal litter box. Therefore, while ensuring safety, it is possible to suppress accumulation of the excrement at the extending bottom part and to easily keep the animal litter box clean.

### [Overall Structure]

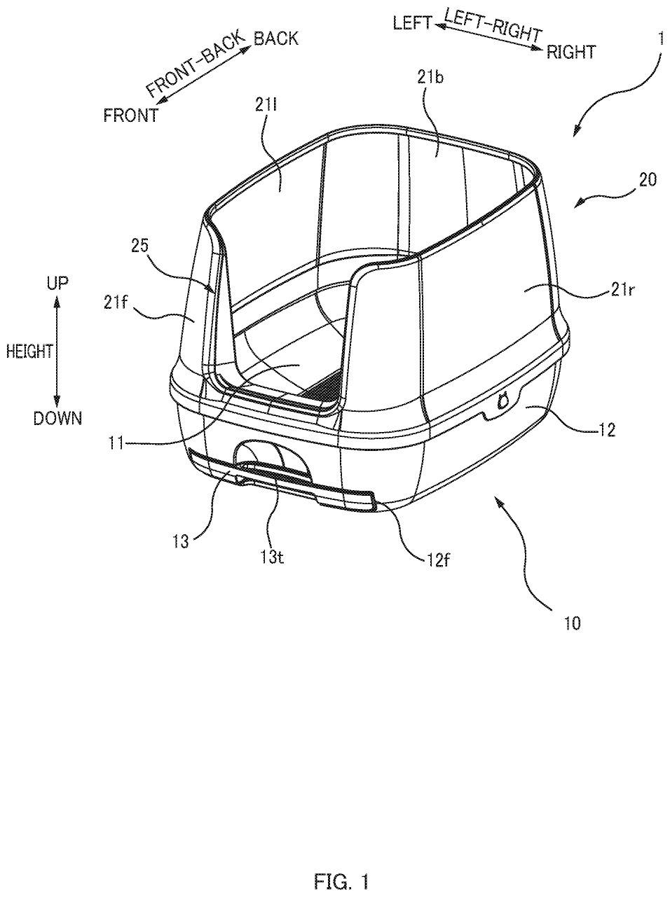

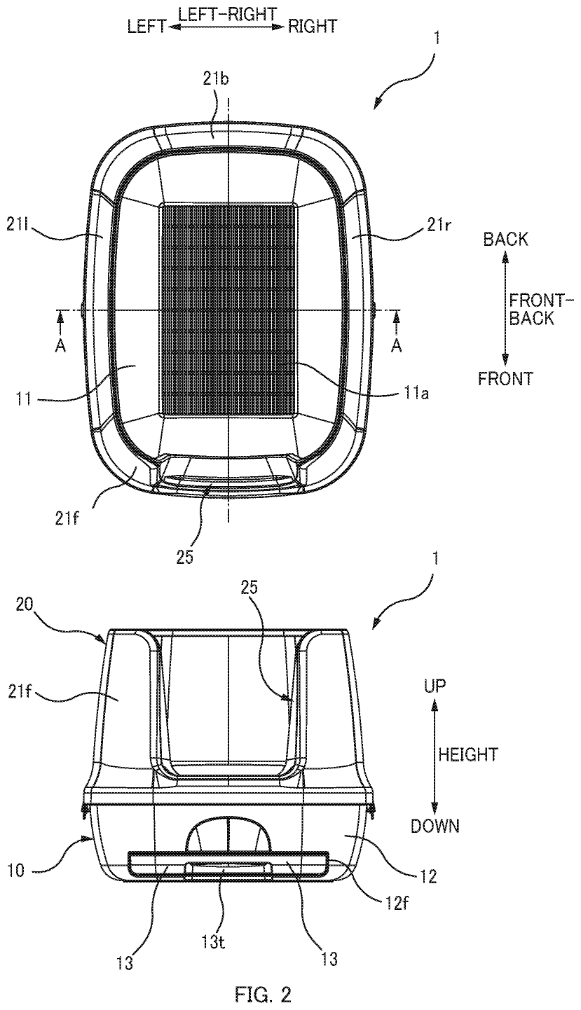

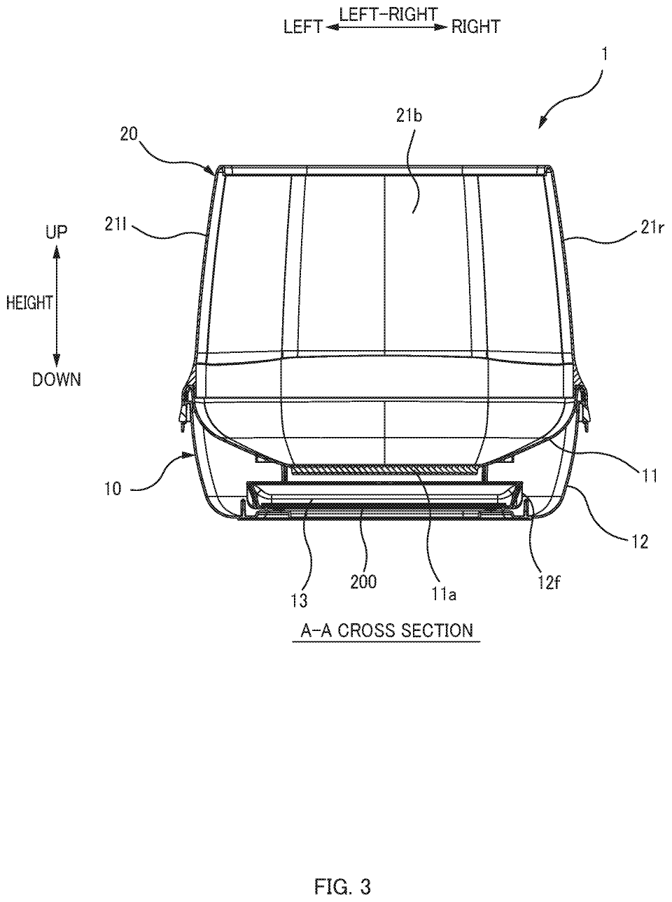

According to one or more embodiments, as an example of the animal litter box, an animal litter box 1 is described. FIG. 1 is a schematic perspective view of the animal litter box 1. FIG. 2 is a plan view of the animal litter box 1 when seen from the upper side in the height direction and from the front side in the front-back direction. FIG. 3 is a cross-sectional view taken along line A-A in FIG. 2. In the description below, as shown in FIG. 1, the “front-back direction”, the “left-right direction”, and the “height direction”, which are three directions perpendicular to each other, are defined. In FIG. 1, the “front-back direction” is a direction in the longitudinal direction of the animal litter box 1, and the side where an entrance/exit for an animal is provided is the front side. The “left-right direction” is a direction in the width direction of the animal litter box 1. The “height direction” is a direction in the vertical direction.

The animal litter box 1 includes a main body part 10 (main body) that receives excrement of an animal and a cover part 20 (cover) that is removably mounted to the upper portion of the main body part 10 in the height direction. The details of the cover part 20 are described later.

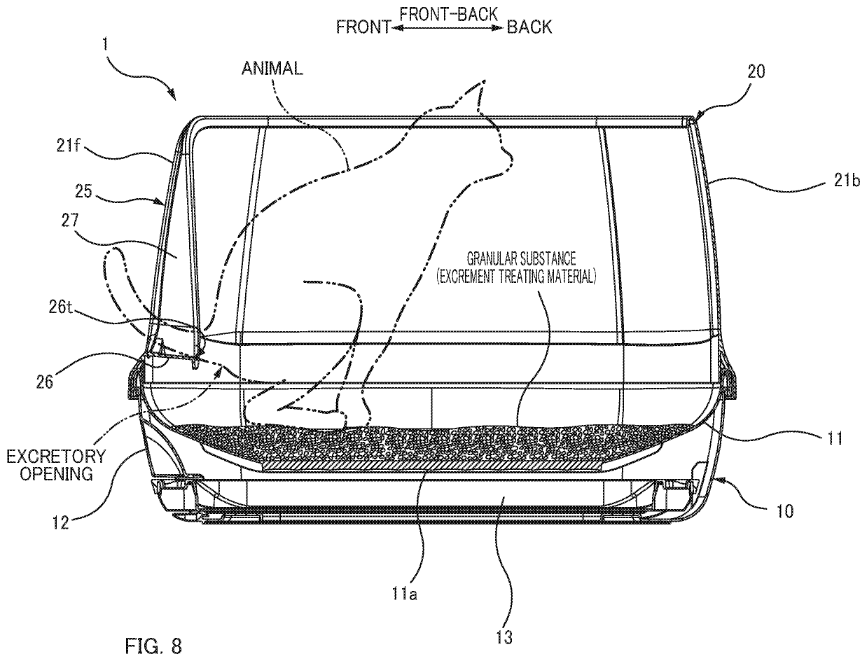

The main body part 10 includes an upper container 11, a lower container 12, and a tray 13. The upper container 11 is a box-shaped member having an open top. An animal (e.g., a cat) is on a bottom surface of the upper container 11 (corresponding to an inner side of the box) when it discharges excrement (see FIG. 8). The main body part 10 of the present embodiment when seen from above has a longitudinally-elongated rectangular shape whose length in the front-back direction is longer than its length in the left-right direction as shown in FIG. 2, but the shape is not limited thereto. As shown in FIG. 3, the bottom surface of the upper container 11 is inclined in a bowl-shaped manner, from an outer side to the inner side (toward center) in a lateral direction (and the front-back direction). In its bottom portion located at the lowest position in the height direction, provided is a urine passage part 11a through which urine or the like discharged by the animal pass from the upper side to the lower side in the height direction. The urine passage part 11a has a plurality of holes extending therethrough in the height direction, and the discharged urine passes through the holes and moves from an upper side toward the lower side of the upper container 11 (toward the lower container 12 side).

In using the animal litter box 1, an excrement treating material that is granular (e.g., cat sand) is disposed on an upper surface of the urine passage part 11a, and an animal such as a cat discharges excrement onto the excrement treating material (see FIG. 8, for example). The excrement treating material used in the animal litter box 1 is a granular substance having a porous structure, such as zeolite or silica gel. When the excrement treating material comes into contact with the urine or the like discharged from the animal, the excrement treating material can absorb an ammonia component, deodorize the animal litter box 1 and dehumidify the animal litter box 1. In order to suppress each particle of the excrement treating material from falling from the holes of the urine passage part 11a, each hole of the urine passage part 11a have a shape and a size that do not allow the excrement treating material to pass through the holes of the urine passage part 11a while allowing the urine to pass through the holes of the urine passage part 11a. For example, in the animal litter box 1 of the present embodiment, the urine passage part 11a is formed by providing a plurality of slit-like holes elongated in the front-back direction as shown in FIG. 2.

The lower container 12 is a box-shaped member having an open top, and, as shown in FIG. 3, is stacked upon and assembled onto the lower portion of the upper container 11. A tray accommodating part 12f that accommodates the tray 13 is provided in the lower container 12. In the animal litter box 1 of the present embodiment, the tray accommodating part 12f has an opening in the lower portion of the lower container 12 on the front side in the front-back direction, and is capable of accommodating the tray 13 inside the lower container 12 from the opening.

The tray 13 is a flat box-shaped container having a shallow bottom where an absorbent body (such as an absorbent body 200 described below) that absorbs discharged urine or the like is installed. In the present embodiment, the tray 13 is formed in a rectangular shape that is symmetrical in the front-back direction. Two gripping parts 13t are respectively provided on the front-back-direction end portions of the tray 13. When the tray 13 is to be accommodated in the lower container 12 or is to be drawn out from the lower container 12, gripping and manipulating the gripping parts 13t makes it possible to slide the tray 13 in the front-back direction. As described above, since the tray 13 of the present embodiment has a symmetrical shape in the front-back direction, the tray 13 can be accommodated in the lower container 12 even if transposing front and back portions of the tray 13.

The absorbent body 200 that is installed inside the tray 13 is a liquid-absorbent sheet member that absorbs urine discharged from an animal such as a cat, and is made of a liquid-absorbent material such as pulp fiber or a super absorbent polymer. The absorbent body 200 may contain a deodorizing microcapsule or an antibacterial agent to prevent multiplication of bacteria while confining the smell of the absorbed urine. In using the animal litter box 1, when the tray 13 in which the absorbent body 200 is installed is accommodated in the tray accommodating part 12f of the lower container 12, the absorbent body 200 is disposed below the urine passage part 11a in the height direction (see FIG. 3). Excrement discharged by the animal (e.g., a cat) in the upper container 11 passes through the urine passage part 11a, moves downward (falls), and is absorbed by the absorbent body 200.

### [Cover Part 20]

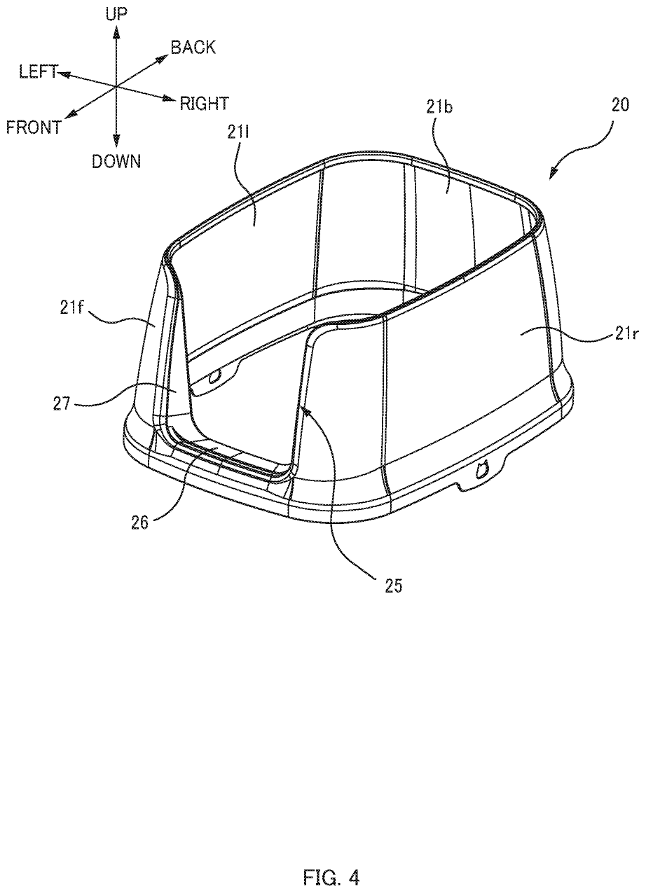

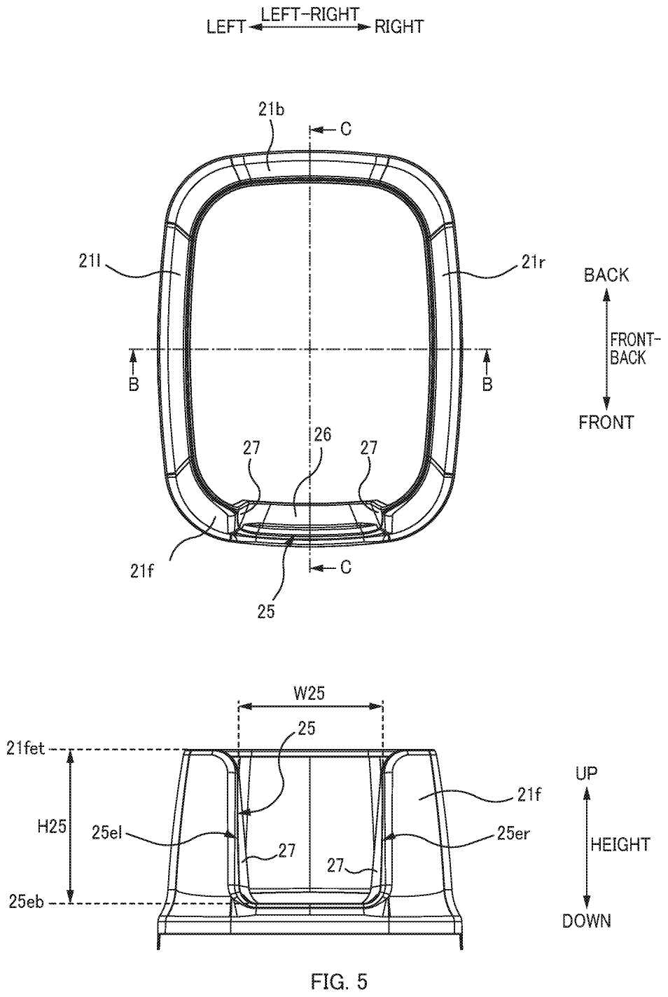

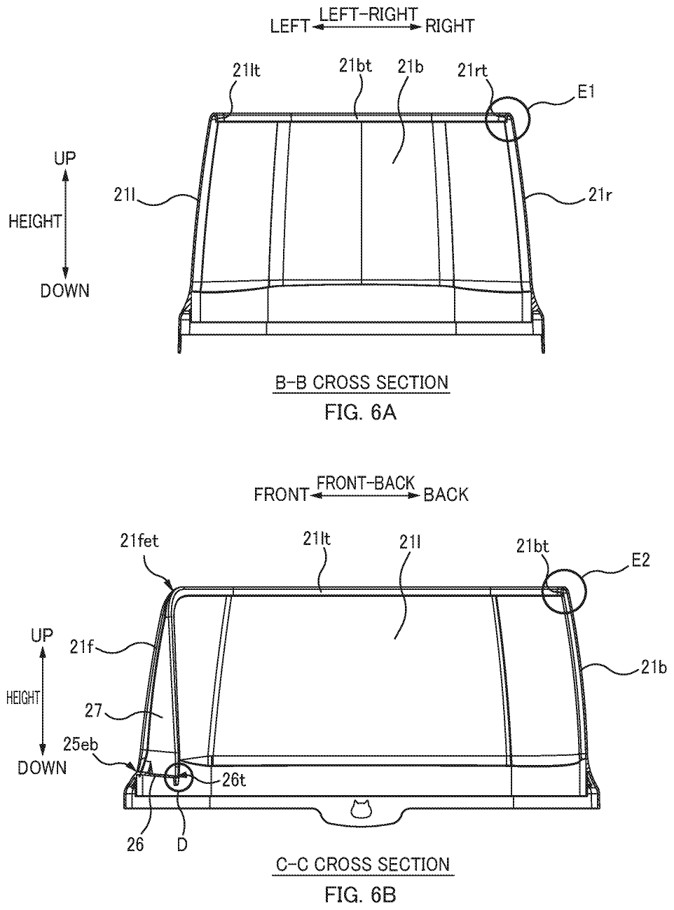

FIG. 4 is a schematic perspective view of the cover part 20. FIG. 5 is a plan view of the cover part 20 when seen from above and front. FIG. 6A is a cross-sectional view taken along line B-B in FIG. 5. FIG. 6B is a cross-sectional view taken along line C-C in FIG. 5.

The cover part 20 includes wall parts 21 (walls) on the four sides in the front-back direction and the left-right direction. For example, the cover part 20 includes a front wall part 21f on the front side and a back wall part 21b on the back side in the front-back direction, and also includes a right wall part 21r on the right side and a left wall part 211 on the left side in the left-right direction. And, the cover part 20 does have an open top at its ceiling (upper side in the height direction). The height of each wall part 21 is adjusted to the following height: an animal (e.g., a cat) that enters the animal litter box 1 can sufficiently obscure its body; and the animal can check the outside of the animal litter box 1 by moving its head (eyes) above any wall part 21 when necessary.

The wall parts 21f, 21b, 21r, and 211 are respectively disposed to be inclined inward in the front-back direction and the left-right direction. That is, each wall part 21 is disposed extending from the lower side to the upper side in the height direction so as to be inclined from the outer side toward the inner side in the front-back direction or the left-right direction. Accordingly, the front-back-direction distance between the front wall part 21f and the back wall part 21b becomes narrower toward the upper side (see FIG. 6B), and the left-right-direction distance between the right wall part 21r and the left wall part 211 is narrower toward the upper side (see FIG. 6A). Consequently, the cover part 20 has a structure that slightly narrows toward an opening at its ceiling, making it possible to efficiently suppress the excrement treating material (such as cat sand) or excrement from being scattered out of the animal litter box 1.

The cover part 20 has a cutout 25 in at least one location in the wall parts 21 provided on the four sides, the cutout 25 serving as an entrance/exit when an animal enters or exits the animal litter box 1. In the present embodiment, the cutout 25 is formed in a portion of the front wall part 21f on the front side in the front-back direction, and allows the animal such as a cat to enter or exit the animal litter box 1 from the cutout 25. Since the animal litter box 1 is longer in length in the front-back direction than in the left-right direction as shown in FIG. 1, the cutout 25 that is the entrance/exit provided in a short side of the rectangle makes it easier for the animal such as a cat to enter or exit the animal litter box 1 in the front-back direction.

The cutout 25 is formed from the upper end of the front wall part 21f to a substantially lower end of the front wall part 21f in the height direction. In FIG. 5, the length (the height) from an upper end 21fet of the front wall part 21f to a lower end 25eb of the cutout 25 is denoted by H25. Setting the length H25 to be as long as possible makes it possible to reduce the height of the entrance/exit (that is, the height of the lower end 25eb of the cutout 25). Accordingly, the legs of an animal that enters or exits the animal litter box 1 are not easily caught. On the other hand, the cutout 25 is formed so as to have a predetermined lateral width and so that the center position is in accordance with the lateral center position of the animal litter box 1. In FIG. 5, the left-right-direction length (width) W25 between the right end 25er and the left end 25e1 of the cutout 25 is substantially constant, but the width W25 on the upper side may differ from the width W25 on the lower side in the height direction. For example, if the width W25 at the upper end 21fet on the upper side in the height direction is wider than the width W25 at the lower end 25eb on the lower side in the height direction, it is possible to make it less likely for the torso of an animal to become caught in the cutout 25 when the animal enters or exits the animal litter box 1.

The cutout 25 is provided with portions extending inward from its peripheral edge. That is, as shown in FIG. 6B, the cutout 25 has an extending bottom part 26 extending from a lower end portion of the cutout 25 (the lower end 25eb in the present embodiment) toward the inner side in the front-back direction (from the front side toward the back side in FIG. 6B). Similarly, the cutout 25 is provided with extending side parts 27 and 27 extending inward in the front-back direction from the right end 25er and the left end 25e1 of the cutout 25, respectively. In the animal litter box 1, the foregoing extending bottom part 26 provided in the cutout 25 which serves as the entrance/exit makes it easier to suppress leakage of excrement from the entrance/exit when the animal such as a cat discharges the excrement.

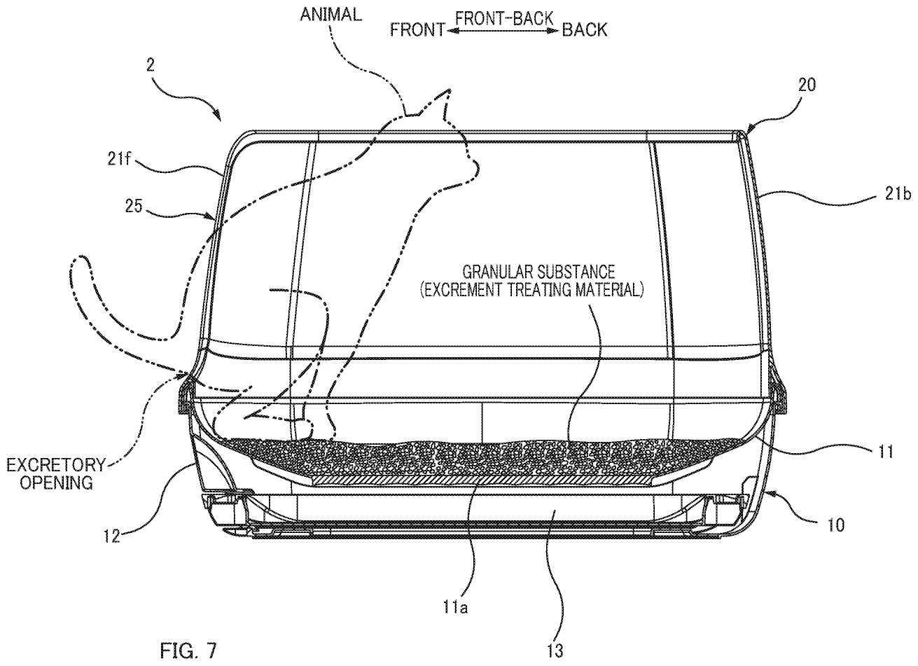

FIG. 7 is a diagram illustrating a state in which an animal discharges excrement in an animal litter box 2 according to a comparative example. FIG. 8 is a diagram illustrating a state in which an animal discharges excrement in the animal litter box 1. FIGS. 7 and 8 both illustrate cross-sections of the animal litter box taken at the center position in the left-right direction.

In the animal litter box 2 of the comparative example shown in FIG. 7, the cutout 25 that is the entrance/exit does not have extending portions. That is, the animal litter box 2 does not include parts corresponding to the extending bottom part 26 and the extending side parts 27 of the animal litter box 1 of the present embodiment. The other structures are substantially the same as the structures of the animal litter box 1. When an animal such as a cat uses the foregoing animal litter box 2 to discharge excrement, the animal that has entered the animal litter box 2 from the cutout 25 (the entrance/exit) may start discharging excrement while facing backward in the front-back direction without advancing toward the far side. That is, as shown in FIG. 7, the animal may discharge the excrement at a position immediately near the front wall part 21f where the cutout 25 is provided. In this case, even if both legs of the animal are positioned inside the animal litter box 2, its excretory opening is positioned beyond outside the front wall part 21f, causing a risk that the excrement such as feces or urine fall out of or get scattered out of the animal litter box 2. For example, in the case of a kitten that is not sufficiently trained to use the animal litter box or an old cat whose legs are weak, when it discharges excrement, the excrement easily leaks from the animal litter box.

In contrast, since the animal litter box 1 of the present embodiment has the extending bottom part 26, the positions of the hind legs of the animal inside the toilet are located inside an extending end 26t, which is an inner end of the extending bottom part 26 in the front-back direction, as shown in FIG. 8. That is, when the animal enters the animal litter box 1, the animal advances up to a position situated away from the cutout 25 (the front wall part 21f) in correspondence with the amount of inward extension of the extending bottom part 26. When the animal enters the animal litter box 1 through the cutout 25 (the entrance/exit), the extending bottom part 26 extending inward from the lower end 25eb of the entrance/exit functions like a footboard and makes it easier for the animal to advance into the toilet. For example, when the animal enters the animal litter box 1 from the entrance/exit, the animal can comfortably move onto cat sand (excrement treating material) after temporarily putting its legs on the extending end 26t. That is, the extending bottom part 26 becomes a foothold, and the animal is safely guided to the urine passage part 11a where the excrement treating material is placed.

Therefore, compared to the state in FIG. 7, the animal that has entered the animal litter box 1 from the cutout 25 (the entrance/exit) is allowed to discharge the excrement after advancing close to the far side (the back side in the front-back direction) of the toilet. Therefore, the excretory opening is not easily positioned outside beyond the front wall part 21f, suppressing leakage of the excrement from the cutout 25 (the entrance/exit).

According to one or more embodiments, in the animal litter box 1, the distance in the front-back direction between the lower end 25eb of the cutout 25 and the extending end 26t of the extending bottom part 26 (that is, the extension length of the extending bottom part 26 in the front-back direction) is within the range from 1 cm to 10 cm (both inclusive). If the extension length is less than 1 cm, it becomes difficult to sufficiently guide the animal to the far side of the toilet in the front-back direction. In addition, there is also a risk that, when a cat puts its legs (for example, its forelegs) on the extending bottom part 26 to enter the toilet, safety is less likely to be ensured because the short extension length of the extending bottom part 26 (that is, the narrow width in the front-back direction) makes it easier for the cat to lose its footing. On the other hand, that the extension length is longer than 10 cm makes narrow the space where the animal discharges excrement in the toilet, and as a result the animal may feel stressed or may not want to use the animal litter box 1. In contrast, when the extension length of the extending bottom part 26 is in the aforementioned range, the animal can be allowed to easily and safely discharge the excrement at a proper location inside the animal litter box 1 without feeling stressed.

However, in the state in FIG. 8, the animal may discharge the excrement onto the extending bottom part 26. In this case, for example, urine may move along an upper surface of the extending bottom part 26 and flow out of the cutout 25. Therefore, in the animal litter box 1, the extending bottom part 26 is disposed so as to be inclined obliquely downward from the outer side to the inner side of the wall part 21. In other words, the extending bottom part 26 is inclined obliquely downward, from the outer side to the inner side of the front wall part 21f in the front-back direction. And the position of the extending end 26t of the extending bottom part 26 is set lower in the height direction than the position of the lower end 25eb of the cutout 25 (see FIG. 6B and FIG. 8). In this way, by disposing the extending bottom part 26 so as to be inclined obliquely downward toward the inner side of the main body part 10, even if, for example, urine is discharged onto the upper surface of the extending bottom part 26, the excrement moves along the inclination of the extending bottom part 26 toward the inner side of the main body part 10 and falls into the main body part 10 (onto the excrement treating material) from the extending end 26t. This makes it easier to further suppress leakage of the excrement from the cutout 25 (the entrance/exit).

According to one or more embodiments, in the animal litter box 1, of the angles that a straight line connecting the lower end 25eb of the cutout 25 and the extending end 26t of the extending bottom part 26 form with a horizontal plane (in the front-back direction in FIG. 6B), the smaller angle (that is, the inclination angle of the extending bottom part 26) be in the range of 5 degrees or greater and 45 degrees or less. If the inclination angle is less than 5 degrees, excrement (e.g., urine) discharged onto the upper surface of the extending bottom part 26 does not easily flow and easily accumulates on the upper surface of the extending bottom part 26. On the other hand, if the inclination angle is greater than 45 degrees, there is also a risk that, when the animal puts its legs on the extending bottom part 26 to enter the animal litter box 1, safety is impaired because the legs easily slip. In contrast, when the inclination angle is in the aforementioned range, while ensuring safety, it is possible to suppress accumulation of the excrement at the extending bottom part 26 and to easily keep the animal litter box 1 clean.

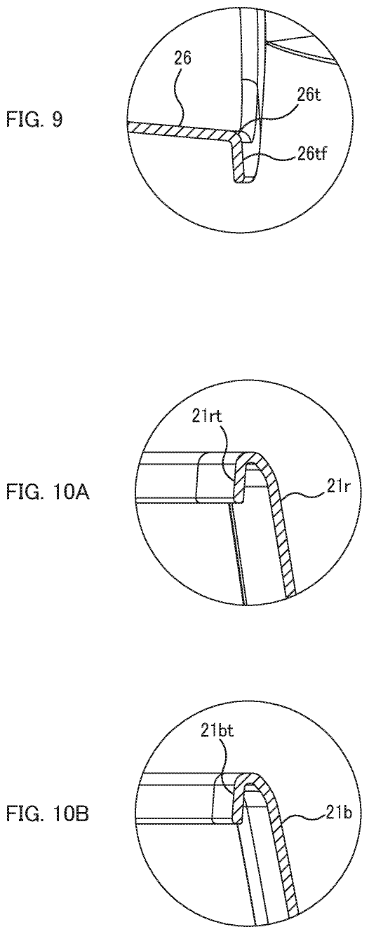

The extending bottom part 26 includes an extending-end bent part 26tf at the extending end 26t, the extending-end bent part 26tf being bent downward in the height direction. FIG. 9 is an enlarged cross-sectional view of a region D of FIG. 6B. In FIG. 9, the shape of a cross section made by cutting the extending bottom part 26 vertically in the front-back direction is indicated by oblique lines. As shown in FIG. 9, the extending bottom part 26 is bent downward at the extending end 26t in the height direction while being inclined obliquely downward from the outer side toward the inner side in the front-back direction, as a result of which the extending-end bent part 26tf is formed. Therefore, when excrement (e.g., urine) is discharged to the upper surface of the extending bottom part 26 and moves along an inclined surface of the extending bottom part 26, the excrement quickly falls downward (that is, falls into the main body part 10) along the extending-end bent part 26tf without accumulating in the vicinity of the extending end 26t. Consequently, the excrement does not easily leak from the animal litter box 1, and the surface of the extending end 26t is not easily soiled.

In general, animals, such as cats, often paw cat sand (a granular substance, such as an excrement treating material) with their legs after discharging excrement. In the animal litter box 2 of the comparative example shown in FIG. 7, when the animal paws the sand (the excrement treating material) with its hind legs, the pawed sand may be scattered out of the toilet from the entrance/exit (the cutout 25). In contrast, in the animal litter box 1 of the present embodiment, even if the animal paws the sand with its hind legs, scattering of the sand is stopped by the extending bottom part 26, as a result of which it is possible to suppress scattering of the sand out of the animal litter box 1. Further, by forming the extending-end bent part 26tf at the extending end 26t, it becomes easier to suppress scattering of the pawed sand to an upper-surface side of the extending bottom part 26 caused by the pawed sand moving beyond the extending end 26t from a lower-surface side of the extending bottom part 26.

On both the left and right sides of the cutout 25, the extending side parts 27 and 27 extending inward from the right end 25er and the left end 25e1, respectively, are provided, and therefore, similarly to the extending bottom part 26, when an animal enters the animal litter box 1, the animal is easily guided to a position situated away from the cutout 25 (the front wall part 21f) in correspondence with the amount of inward extension of each extending side part 27. In the present embodiment, since two sides of the extending bottom part 26 are supported by the extending side parts 27, the strength of the extending bottom part 26 can be higher than when extending side parts 27 are not provided. Therefore, when the animal enters the animal litter box 1, even if the weight of the animal is exerted upon the extending bottom part 26, the extending bottom part 26 is not easily flexed or damaged, and a safe animal litter box 1 can be provided. Further, when the animal enters the animal litter box 1 via the cutout 25 (the entrance/exit), since the extending bottom part 26 and both extending side parts 27 and 27 extend in an advancing direction (that is, a direction of the inner side of the animal litter box 1), it is possible to naturally guide the animal in the advancing direction.

In the animal litter box 1, the length of inward extension of each extending side part 27 from a corresponding one of the right end 25er and the left end 25e1 is larger toward the lower side in the height direction (see, for example, FIG. 8). In other words, the width of each extending side part 27 in the front-back direction is narrower on the upper side than on the lower side in the height direction, and the width gradually widens from the upper end 21fet of the front wall part 21f toward the extending bottom part 26 on the lower side in the height direction.

A region in the vicinity of the upper end 21fet of the front wall part 21f is at a height at which the head passes when an animal such as a cat enters or exits the animal litter box 1. Therefore, by making the areas of the extending side parts 27 in this region as small as possible, it becomes less likely for the animal to bump its head when the animal enters or exits the animal litter box 1. This makes it possible to prevent the animal from being pressured. On the other hand, a region in the vicinity of the extending bottom part 26 is at a height at which the legs and torso passes when the animal such as a cat enters or exits the animal litter box 1. Therefore, by making each extending side part 27 in this region as wide a plane as possible, it becomes less likely to generate a localized pressure even if a large force acts due to the animal bumping, for example, its legs when the animal enters or exits the animal litter box 1. This can make it less likely for the extending side parts 27 to be damaged and for the animal's body to be injured. Consequently, the animal can safely and smoothly enter or exit the animal litter box 1.

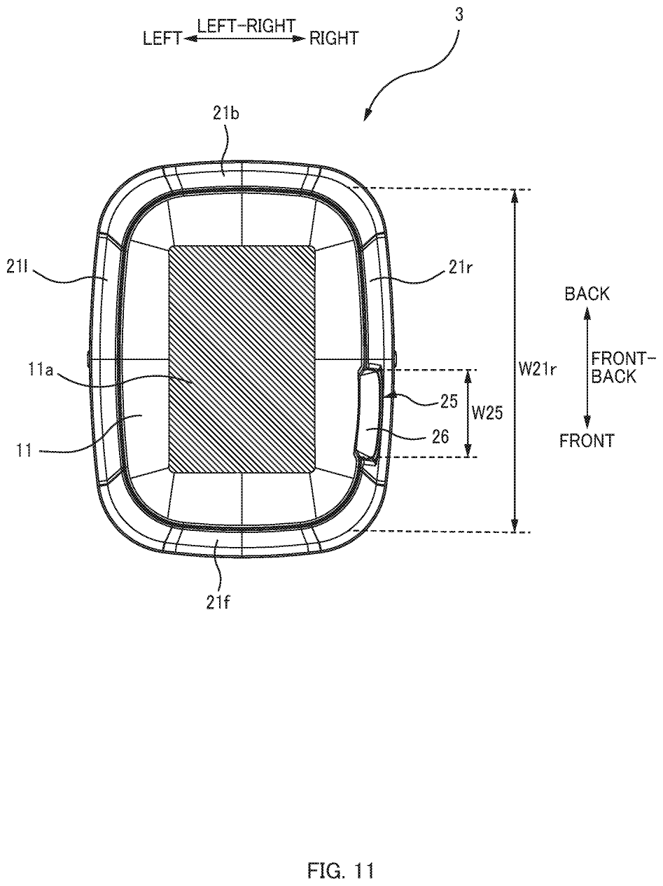

The wall parts 21f, 21b, 21r, and 211 that are disposed on the four sides of the cover part 20 include a reverse part 21ft, a reverse part 21bt, a reverse part 21rt, and a reverse part 211t, respectively, extending inward with respect to the respective wall parts 21 from corresponding upper ends. FIG. 10A is an enlarged view of a region E1 of FIG. 6A. FIG. 10B is an enlarged view of a region E2 of FIG. 6B. FIG. 10A shows the reverse part 21rt in which an upper end portion of the right wall part 21r is bent downward in the height direction while extending in the left-right direction toward the left side (that is, the inner side of the animal litter box 1). Similarly, FIG. 10B shows the reverse part 21bt in which an upper end portion of the back wall part 21b is bent downward in the height direction while extending in the front-back direction toward the front side (that is, the inner side of the animal litter box 1).

As described above, animals (e.g., cats) that have discharged excrement inside the animal litter box often paw cat sand (a granular substance, such as an excrement treating material) with their legs after discharging the excrement. In addition, when particle sizes of the excrement treating material are small or particles are light, the particles of the excrement treating material that has been pawed may fly out of the animal litter box due to the particles of the excrement treating material that has been pawed being largely scattered and moving over the upper ends of the wall parts. In contrast, in the animal litter box 1 of the present embodiment, as shown in FIGS. 10A and 10B, since the reverse parts (21rt, 21bt, etc.) extending inward from the upper ends of the respective wall parts 21 of the cover part 20 are provided, the scattered particles tend to fall toward the inner side of the toilet by colliding with the reverse parts. Therefore, it is possible to easily suppress the particles of the excrement treating material from moving over the upper ends of the wall parts 21 and from flying out to the outer side.

### Modified Example

Although according to one or more embodiments the animal litter box 1 in which the entrance/exit (the cutout 25) is provided in the front wall part 21f on the front side in the front-back direction has been described, the location of the entrance/exit is not limited to the front side (or may be the back side) in the front-back direction. For example, the entrance/exit (the cutout 25) may be provided in the left wall part 21r on the right side in the left-right direction, or may be provided in the right wall part 211. FIG. 11 is a diagram illustrating an animal litter box 3 having a cutout 25 in the right wall part 21r as a modified example of the animal litter box 1 according to one or more embodiments.

In the animal litter box 3 of the modified example, as shown in FIG. 11, the cutout 25 that is an entrance/exit is provided in a portion of a long side of a rectangle. For example, of the right wall part 21r of the cover part 20, the cutout 25 is provided at a location that is closer than the center in the front-back direction to the front side. The size of the entire animal litter box 3 is approximately twice the size of the animal litter box 1, and is a size on the order of the total size of two animal litters 1 shown in FIG. 1 placed side by side in the left-right direction. In the animal litter box 3, the basic function and configuration of each part (such as the main body part 10 and the cover part 20) other than the disposition of the cutout 25 are substantially the same as those of the animal litter box 1. Therefore, detailed descriptions of each of the parts are not given. Naturally, the direction in which the tray 13 is drawn out and details of, for example, the structure of the urine passage part 11a can be changed.

The animal litter box 3 has a larger overall size than that of the animal litter box 1 and correspondingly has a wider excrement dischargeable range (a range in which the urine passage part 11a is provided). Therefore, when discharging excrement, an animal such as a cat can avoid a location on which excrement has already been discharged and select a clean location on which excrement has not yet been discharged inside the animal litter box 3. Therefore, the animal easily discharges the excrement without feeling stressed, and, for example, an owner can reduce the frequency with which the animal litter box 3 is cleaned. Since the range in which the absorbent body 200 is installed is also wide, it is possible to increase the absorbent capacity of, for example, urine in terms of the entire toilet. Therefore, it is possible to reduce the frequency with which the absorbent body 200 is exchanged.

Even in such an animal litter box 3, similarly to the animal litter box 1, an extending bottom part 26 and extending side parts 27 extending inward from a peripheral edge of the cutout 25 are formed. Therefore, the animal that has advanced into the animal litter box 3 from the entrance/exit (the cutout 25) is easily guided toward the inner side (the far side in the advancing direction) of the animal litter box 3, and escape of the excrement to the outer side can be effectively suppressed from occurring.

In the animal litter box 3, the entrance/exit (the cutout 25) is provided in a location that is displaced from the center of a long side of the rectangle (the front-back direction of FIG. 11). In other words, in the front-back direction, the center of the cutout 25 is situated at a location that is decentered from the center of the animal litter box 3. In the example of FIG. 11, in the front-back direction of the animal litter box 3, the cutout 25 is provided at a location that is decentered forward of the center. Ordinarily, an animal that uses the animal litter box discharges excrement along a straight line in the advancing direction when the animal enters the toilet from the entrance/exit. Therefore, if the entrance/exit is provided in the center in the longitudinal direction, the animal tends to discharge the excrement in the vicinity of a central region in the longitudinal direction, and, in the central region, the urine absorption amount of the absorbent body 200 immediately reaches a saturated state, as a result of which it becomes necessary to exchange the absorbent body 200 frequently. That is, even if the excrement dischargeable range is wide, the actual discharge region is limited to a narrow range.

In contrast, as in the present modified example, by causing the location of the entrance/exit to be decentered, the animal litter box 3 allows the use of a wider area. For example, in the animal litter box 3 of FIG. 11, first, the animal discharges excrement in a front region in the front-back direction where the entrance/exit (the cutout 25) is provided. When the front region becomes soiled, the animal tries to discharge excrement in a back region in the front-back direction where excrement has not yet been discharged. That is, a place in the vicinity of the entrance where excrement can be easily discharged and a place situated away from the entrance where excrement cannot be easily discharged are used in this order. Therefore, the animal litter box 3 is easily used efficiently over a wide range. Further, the frequency with which the absorbent body 200 is exchanged can be reduced.

As in the animal litter box 3, when the entrance/exit is provided in a portion of a long side of the rectangle, the maximum value of the width of the entrance/exit is ½ (half) or less of the maximum value of the width of the wall part where the entrance/exit is provided. Even in the example of FIG. 11, the width W25 of the cutout 25 (the entrance/exit) in the front-back direction is ½ or less of width W21r in the front-back direction of the right wall part 21r where the cutout 25 is provided (W21r×½≥W25). As long as such a structure is used, it is possible to restrict the location where the animal advances into the toilet by a certain extent. That is, of the wall part that is elongated in the longitudinal direction, it is possible to allow the animal to enter or exit from desired locations. Therefore, similarly to the above-described case, a place in the vicinity of the entrance where excrement can be easily discharged in the longitudinal direction and a place situated far from the entrance where excrement cannot be easily discharged in the longitudinal direction are easily provided. Therefore, the entire region of the animal litter box 3 is used efficiently.

### Other Embodiments

Although embodiments of the present disclosure have been described hereinabove, the above embodiments of the present disclosure are simply to facilitate understanding of the present disclosure and are not in any way to be construed as limiting the present disclosure. The present disclosure may variously be changed or altered without departing from its gist and encompass equivalents thereof. For example, a modified example as described below is possible.

In the above-described embodiment, the cutout 25 that is the entrance/exit is formed in one location among locations on the wall parts 21 that define the cover part 20 in the front-back direction and the left-right direction. However, the number of entrances/exits is not limited to one and may be two or more.

In the above-described embodiment, although a granular excrement treating material, such as cat sand, is placed on the bottom portion of the upper container 10, it is not limited thereto in any way.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1 animal litter

2 animal litter box (comparative example)

3 animal litter box (modified example)

10 main body part

11 upper container, 11a urine passage part

12 lower container, 12f tray accommodating part

13 tray, 13t gripping part

20 cover part

21 wall part

21f front wall part, 21fet upper end, 21ft reverse part

21b back wall part, 21bt reverse part

21r right wall part, 21rt reverse part

211 left wall part, 211t reverse part cutout

25eb lower end, 25er right end, 25e1 left end

26 extending bottom part, 26t extending end, 26tf extending-end bent part

27 extending side part

200 absorbent body

H25 height (cutout), W25 width (cutout)

W21r width (right wall part)

What is claimed is:

1. An animal litter box having a front-back direction, a left-right direction, and a height direction, comprising:
a main body that receives excrement of an animal; and
a cover that is removably mounted to an upper portion of the main body, wherein
the cover comprises walls on front-back-direction sides and on left-right-direction sides,
the cover comprises an open top at a ceiling,
the cover comprises a cutout in at least one of the walls,
the cutout serves as an entrance/exit when the animal enters or exits the animal litter box, and
the cover comprises an extending bottom that extends from a lower end portion of the cutout to an inner side of the at least one of the walls.

2. The animal litter box according to claim 1, wherein
the extending bottom is inclined obliquely downward from an outer side of the at least one of the walls to the inner side.

3. The animal litter box according to claim 2, wherein
the extending bottom comprises a bent part at an extending end extending toward the inner side, and
the bent part is bent downward in the height direction.

4. The animal litter box according to claim 1, wherein
the cover comprises extending sides that extend from two left-right-direction ends of the cutout to the inner side.

5. The animal litter box according to claim 4, wherein
a width of each of the extending sides is larger toward a lower side of the height direction.

6. The animal litter box according to claim 1, wherein
each of the walls comprises a reverse part that extends from a corresponding upper end of each of the walls in the height direction to an inner side of each of the walls.

7. The animal litter box according to claim 1, wherein
a length of the cover in the front-back direction is longer than a length of the cover in the left-right direction, and
the cutout is provided in the at least one of the walls disposed on a front side or a back side in the front-back direction.

8. The animal litter box according to claim 1, wherein
a length of the cover in the front-back direction is longer than a length of the cover in the left-right direction, and
the cutout is provided in the at least one of the walls disposed on a right side or a left side in the left-right direction.

9. The animal litter box according to claim 8, wherein
in the front-back direction, a location of a center of the cutout is decentered forward or backward of a location of a center of the animal litter box.

10. The animal litter box according to claim 1, wherein
in the front-back direction, a maximum value of a width of the cutout is half or less of a maximum value of a width of the at least one of the walls.

11. The animal litter box according to claim 1, wherein
an extension length from a lower end of the cutout to an extending end of the extending bottom is between 1 cm to 10 cm (both inclusive).

12. The animal litter box according to claim 1, wherein
the extending bottom is inclined obliquely downward from an outer side to the inner side, and
among angles formed by a horizontal plane and a straight line connecting a lower end of the cutout and an extending end of the extending bottom, a smaller angle is between 5 degrees and 45 degrees (both inclusive).

13. The animal litter box according to claim 2, wherein
the cover comprises extending sides that extend from two left-right-direction ends of the cutout to the inner side.

14. The animal litter box according to claim 3, wherein
the cover comprises extending sides that extend from two left-right-direction ends of the cutout to the inner side.

15. The animal litter box according to claim 2, wherein
each of the walls comprises a reverse part that extends from a corresponding upper end of each of the walls in the height direction to an inner side of each of the walls.

16. The animal litter box according to claim 3, wherein
each of the walls comprises a reverse part that extends from a corresponding upper end of each of the walls in the height direction to an inner side of each of the walls.

17. The animal litter box according to claim 4, wherein
each of the walls comprises a reverse part that extends from a corresponding upper end of each of the walls in the height direction to an inner side of each of the walls.

18. The animal litter box according to claim 5, wherein
each of the walls comprises a reverse part that extends from a corresponding upper end of each of the walls in the height direction to an inner side of each of the walls.

19. The animal litter box according to claim 2, wherein
a length of the cover in the front-back direction is longer than a length of the cover in the left-right direction, and
the cutout is provided in the at least one of the walls disposed on a front side or a back side in the front-back direction.

20. The animal litter box according to claim 3, wherein
a length of the cover in the front-back direction is longer than a length of the cover in the left-right direction, and
the cutout is provided in the at least one of the walls disposed on a front side or a back side in the front-back direction.
